(19) United States
(12) Patent Application Publication
(10) Pub. No.: US 2020/0227979 A1
(43) Pub. Date: Jul. 16, 2020

(54) ROTARY ELECTRIC MACHINE

(71) Applicant: HONDA MOTOR CO., LTD., Tokyo (JP)

(72) Inventors: Tadashi Yamaguchi, Wako-shi (JP); Toru Kishi, Wako-shi (JP); Shigeji Nakano, Wako-shi (JP); Motoshi Togasaki, Wako-shi (JP); Kentaro Yamaguchi, Wako-shi (JP)

(21) Appl. No.: 16/738,093

(22) Filed: Jan. 9, 2020

(30) Foreign Application Priority Data
Jan. 11, 2019 (JP) 2019-003674

(51) Int. Cl. H02K 9/19

(52) U.S. Cl. CPC H02K 9/19

(57) ABSTRACT

A rotary electric machine of the embodiment includes a stator including a cylindrical stator core, and a coil mounted on the stator core, and a rotor disposed radially inward of the stator, wherein the rotor includes a rotor core having a rotor internal flow path through which a refrigerant is able to flow by axial center cooling, and an end surface plate disposed at an end of the rotor core in an axial direction, and the end surface plate includes a refrigerant flow hole configured to communicate with the rotor internal flow path, and a surface treatment portion disposed at least between the refrigerant flow hole and an outer peripheral edge of the end surface plate, and a surface tension of the surface treatment portion is smaller than that of the end surface plate.

### CROSS-REFERENCE TO RELATED APPLICATION

Priority is claimed on Japanese Patent Application No. 2019-003674, filed Jan. 11, 2019, the content of which is incorporated herein by reference.

### BACKGROUND

### Field of the Invention

The present invention relates to a rotary electric machine.

### Description of Related Art

In a rotary electric machine mounted in a hybrid vehicle, an electric vehicle, or the like, a magnetic field is formed in a stator core by supplying a current to a coil, and a magnetic attractive force or a repulsive force is generated between a magnet of a rotor and the stator core. Thus, the rotor rotates with respect to a stator.

Since the rotary electric machine generates heat as it operates, it is cooled by a refrigerant. For example, a refrigerant flow path is provided inside the rotor from the radially inner side to the radially outer side. For example, the rotary electric machine is cooled by the refrigerant by the refrigerant temporarily stored in an inner peripheral portion of the rotor being moved from the radially inner side to the radially outer side through the refrigerant flow path by a centrifugal force accompanying rotation of the rotor.

Incidentally, when the refrigerant is moved from the radially inner side to the radially outer side through the refrigerant flow path by the centrifugal force accompanying the rotation of the rotor, the refrigerant discharged from the refrigerant flow path may flow into a space (an air gap) between an inner peripheral surface of the stator and an outer peripheral surface of the rotor. When refrigerant flows into the space between the inner peripheral surface of the stator and the outer peripheral surface of the rotor, the refrigerant acts as a resistance against the rotation of the rotor, and rotational efficiency of the rotary electric machine may be reduced. Therefore, various constitutions for improving the rotational efficiency of the rotary electric machine have been studied.

For example, Japanese Patent No. 5417960 discloses a structure in which a wall body is provided adjacent to an axial end surface of the rotor in the axial direction and adjacent to the inner peripheral surface of the stator in the radial direction, and the wall body is provided on the side of the inner peripheral surface of the stator with respect to an outflow opening of the refrigerant. In Japanese Patent No. 5417960, flow of the refrigerant which has flowed out from the outflow opening by the wall body into the space between the inner peripheral surface of the stator and the outer peripheral surface of the rotor is suppressed.

### SUMMARY

However, when the wall body is provided on the side of the inner peripheral surface side of the stator with respect to the outflow opening of the refrigerant, the refrigerant which has flowed out from the outflow opening is blocked by the wall body, it thus becomes difficult for the refrigerant to be distributed to the coil of the stator, and the coil may not be efficiently cooled.

The present invention is to provide a rotary electric machine in which the rotational efficiency of the rotary electric machine is able to be improved and in which a coil is able to be efficiently cooled.

A rotary electric machine according to the present invention employs the following configuration.

(1) A rotary electric machine according to one aspect of the present invention including: a stator including a cylindrical stator core and a coil mounted on the stator core, and a rotor disposed radially inward of the stator, wherein the rotor includes a rotor core having a refrigerant flow path through which a refrigerant is able to flow due to axial center cooling, and an end surface plate disposed at an end of the rotor core in an axial direction, the end surface plate includes a refrigerant flow hole configured to communicate with the refrigerant flow path, and a surface treatment portion disposed at least between the refrigerant flow hole and an outer peripheral edge of the end surface plate, and a surface tension of the surface treatment portion is smaller than that of at least one of the end surface plate and the refrigerant.

(2) In the above mentioned aspect of (1), the surface treatment portion may have a film configured to cover at least a space between the refrigerant flow hole and the outer peripheral edge of the end surface plate.

(3) In the aspect of above mentioned (1) or (2), the surface treatment portion may have a fine concavo-convex structure.

(4) In one aspect of any one of above mentioned (1) to (3), the surface treatment portion may have an annular shape along an outer periphery of the end surface plate when seen in the axial direction.

According to the above mentioned aspect of (1), since the end surface plate has at least the surface treatment portion disposed between the refrigerant flow hole and the outer peripheral edge of the end surface plate, the refrigerant which has flowed out from the refrigerant flow hole can flow smoothly along the surface treatment portion due to a centrifugal force accompanying the rotation of the rotor. Therefore, as compared with a case in which the surface treatment portion is not provided, wetting and spreading toward the outer peripheral edge of the end surface plate due to causing the refrigerant which has flowed out from the refrigerant flow hole to remain can be suppressed. In addition, since the surface tension of the surface treatment portion is smaller than that of at least one of the end surface plate and the refrigerant, as compared with a case in which the surface tension of the surface treatment portion is equal to or higher than that of the end surface plate and the refrigerant, the refrigerant flowing on the surface treatment portion can be caused to easily slide. Therefore, due to the centrifugal force accompanying the rotation of the rotor, it is possible to make it easier for the refrigerant flowing on the surface treatment portion to be distributed radially outward. Furthermore, as compared with a structure in which a wall body is provided on the inner peripheral surface side of the stator, the refrigerant which has flowed out from the refrigerant flow hole is likely to be distributed to the coil of the stator. Therefore, the rotational efficiency of the rotary electric machine can be improved, and the coil can be efficiently cooled.

According to the above mentioned aspect of (2), since the surface treatment portion has the film which covers at least a space between the refrigerant flow hole and the outer peripheral edge of the end surface plate, the refrigerant which has flowed out from the refrigerant flow hole can slide on a surface of the film due to the centrifugal force accompanying the rotation of the rotor.

According to the above mentioned aspect of (3), since the surface treatment portion has a fine concavo-convex structure, the contact area between the surface treatment portion and the refrigerant is smaller than when the surface treatment portion is flat (it becomes a non-uniform wet state). Therefore, the refrigerant which has flowed out from the refrigerant flow hole can be repelled by the concavo-convex structure due to the centrifugal force accompanying the rotation of the rotor.

According to the above mentioned aspect of (4), since the surface treatment portion has the annular shape along the outer periphery of the end surface plate when seen in the axial direction, the refrigerant flowing on the surface treatment portion can flow smoothly along the surface treatment portion over the entire periphery of the end surface plate due to the centrifugal force accompanying the rotation of the rotor.

### BRIEF DESCRIPTION OF THE DRAWINGS

FIG. 1 is a schematic constitution diagram of a rotary electric machine according to a first embodiment.

FIG. 2 is an enlarged view of a main part of a rotor according to the first embodiment when seen from the axial direction.

FIG. 3 is a sectional view taken along line III-III in FIG. 2.

FIG. 4 is a diagram showing a contact angle in a surface treatment portion of the first embodiment.

FIG. 5 is an enlarged view of a main part when a rotor according to a comparative example is seen in the axial direction.

FIG. 6 is a cross-sectional view of a surface treatment portion according to a second embodiment.

FIG. 7 is a cross-sectional view of a surface treatment portion according to a first modified example of the second embodiment.

FIG. 8 is a cross-sectional view of a surface treatment portion according to a second modified example of the second embodiment.

FIG. 9 is a cross-sectional view of a surface treatment portion according to a third modified example of the second embodiment.

FIG. 10 is a cross-sectional view of a surface treatment portion according to a fourth modified example of the second embodiment.

### DETAILED DESCRIPTION OF THE INVENTION

Hereinafter, embodiments of the present invention will be described with reference to the drawings. In the embodiments, a rotary electric machine (a traveling motor) mounted in a vehicle such as a hybrid vehicle or an electric vehicle will be described.

### First Embodiment

### <Rotary Electric Machine>

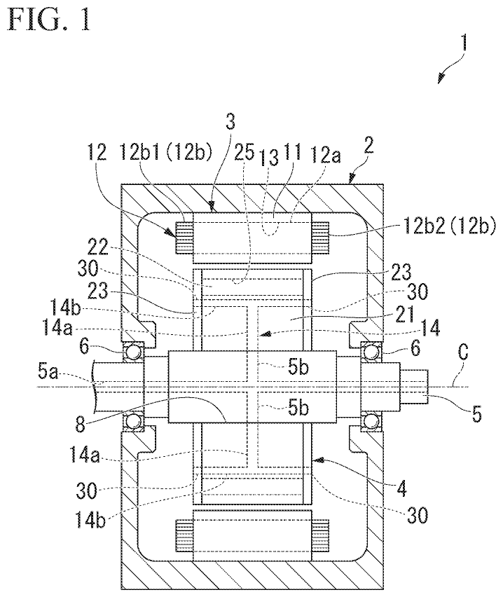

FIG. 1 is a schematic constitution diagram showing the overall constitution of a rotary electric machine 1 according to a first embodiment. FIG. 1 is a view including a cross section cut along a virtual plane including an axis C.

As shown in FIG. 1, the rotary electric machine 1 includes a case 2, a stator 3, a rotor 4, an output shaft 5, and a refrigerant supply mechanism (not shown).

The case 2 has a cylindrical box shape which accommodates the stator 3 and the rotor 4. A refrigerant (not shown) is accommodated in the case 2. A part of the stator 3 is disposed in the case 2 to be immersed in the refrigerant. For example, an automatic transmission fluid (ATF) which is a hydraulic oil used for transmission lubrication, power transmission, or the like is used as the refrigerant.

The output shaft 5 is rotatably supported by the case 2. A reference numeral 6 in FIG. 1 indicates a bearing which rotatably supports the output shaft 5. Hereinafter, a direction along an axis C of the output shaft 5 is referred to as “axial direction”, a direction orthogonal to the axis C is referred to as “radial direction”, and a direction around the axis C is referred to as “circumferential direction”.

The output shaft 5 includes an axial center refrigerant path 5a provided coaxially with the output shaft 5, and a radial refrigerant path 5b which extends radially outward from the axial center refrigerant path 5a. A plurality of radial refrigerant paths 5b are disposed at intervals in the circumferential direction. In the example of FIG. 1, the radial refrigerant path 5b extends radially outward from a center portion of the axial center refrigerant path 5a in the axial direction and is open at an outer peripheral surface of the output shaft 5.

The stator 3 includes a stator core 11 and a coil 12 mounted on the stator core 11.

The stator core 11 has a cylindrical shape disposed coaxially with the axis C. The stator core 11 is fixed to an inner peripheral surface of the case 2. For example, the stator core 11 is constituted by stacking electromagnetic steel plates in the axial direction. The stator core 11 may be a so-called dust core obtained by compression-molding metal magnetic powder.

The coil 12 is mounted on the stator core 11. The coil 12 includes a U-phase coil, a V-phase coil, and a W-phase coil which are disposed with a phase difference of 120° with respect to each other in the circumferential direction. The coil 12 includes an insertion portion 12a which is inserted into a slot 13 of the stator core 11, and a coil end portion 12b which protrudes from the stator core 11 in the axial direction. A magnetic field is generated in the stator core 11 when a current flows through the coil 12. In FIG. 1, a reference numeral 12b1 indicates a first coil end portion, and a reference numeral 12b2 indicates a second coil end portion located on the side opposite to the first coil end portion 12b1 in the axial direction.

The rotor 4 is disposed radially inward with respect to the stator 3 with an interval therebetween. The rotor 4 is fixed to the output shaft 5. The rotor 4 is constituted to be rotatable integrally with the output shaft 5 around the axis C. The rotor 4 includes a rotor core 21, a magnet 22, and an end surface plate 23. In the embodiment, the magnet 22 is a permanent magnet.

The rotor core 21 has a cylindrical shape disposed coaxially with the axis C. The output shaft 5 is press-fitted and fixed inside the rotor core 21 in the radial direction. The rotor core 21 may be constituted by stacking electromagnetic steel plates in the axial direction, as in the stator core 11, or may be a dust core.

A magnet holding hole 25 which passes through the rotor core 21 in the axial direction is provided in an outer peripheral portion of the rotor core 21. A plurality of magnet holding holes 25 are disposed at intervals in the circumferential direction. The magnet 22 is inserted into each of the magnet holding holes 25.

The rotor core 21 has a rotor internal flow path 14 (a refrigerant flow path) through which a refrigerant can flow by axial center cooling. The rotor internal flow path 14 is disposed between the output shaft 5 (a shaft insertion hole 8) and the magnet 22 (the magnet holding hole 25) in the radial direction.

The rotor internal flow path 14 includes a radial flow path 14a which extends in the radial direction and an axial flow path 14b which extends in the axial direction. The radial flow path 14a allows the radial refrigerant path 5b of the output shaft 5 to communicate with the axial flow path 14b of the rotor internal flow path 14. The axial flow path 14b allows a refrigerant flow hole 30 of the end surface plate 23 to communicate with the radial flow path 14a of the rotor internal flow path 14. A plurality of radial flow paths 14a and axial flow paths 14b are disposed at intervals in the circumferential direction.

The end surface plates 23 are disposed at both end portions of the rotor core 21 in the axial direction. The output shaft 5 is press-fitted and fixed inside the end surface plate 23 in the radial direction. The end surface plate 23 covers at least the magnet holding hole 25 of the rotor core 21 from both end sides in the axial direction. The end surface plate 23 is in contact with an outer end surface of the rotor core 21 in the axial direction.

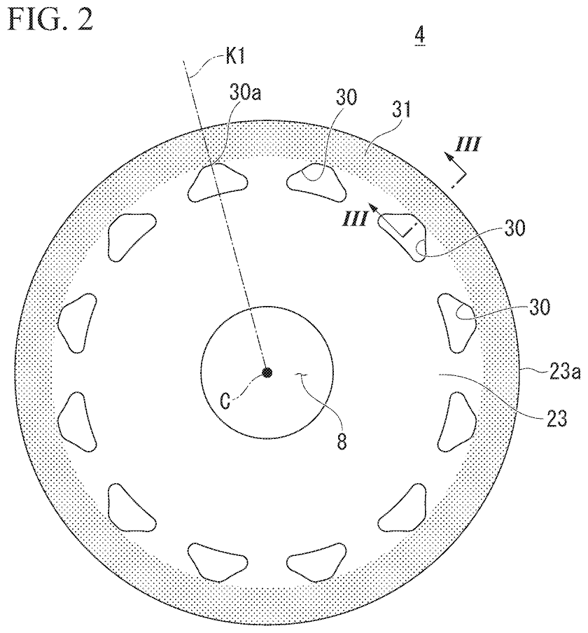

FIG. 2 is an enlarged view of a main part of the rotor 4 according to the first embodiment when seen in the axial direction.

As shown in FIG. 2, the end surface plate 23 includes the refrigerant flow hole 30 which communicates with the rotor internal flow path 14 (refer to FIG. 1), and a surface treatment portion 31 disposed at least between the refrigerant flow hole 30 and the outer peripheral edge 23a of the end surface plate 23. A plurality (for example, twelve in the embodiment) of refrigerant flow holes 30 are disposed at intervals in the circumferential direction.

When seen in the axial direction, each of the refrigerant flow holes 30 has a triangular shape having a top portion 30a on the radially outer side. When seen in the axial direction, each of corner portions of the refrigerant flow hole 30 has a rounded corner shape. When seen in the axial direction, the top portion 30a has a curved shape which is convex radially outward. A reference numeral K1 in the drawing indicates an imaginary straight line which passes through the axial center (the axis C) of the output shaft 5 and the top portion 30a (a radially outer end) of the refrigerant flow hole 30. When seen in the axial direction, the refrigerant flow holes 30 are formed in line symmetry with the virtual straight line K1 as an axis of symmetry.

When seen in the axial direction, the surface treatment portion 31 is disposed between the top portion 30a of the refrigerant flow hole 30 and an outer peripheral edge 23a of the end surface plate 23. When seen in the axial direction, the surface treatment portion 31 has an annular shape along the outer periphery of the end surface plate 23. The surface treatment portion 31 is continuously connected along the outer periphery of the end surface plate 23.

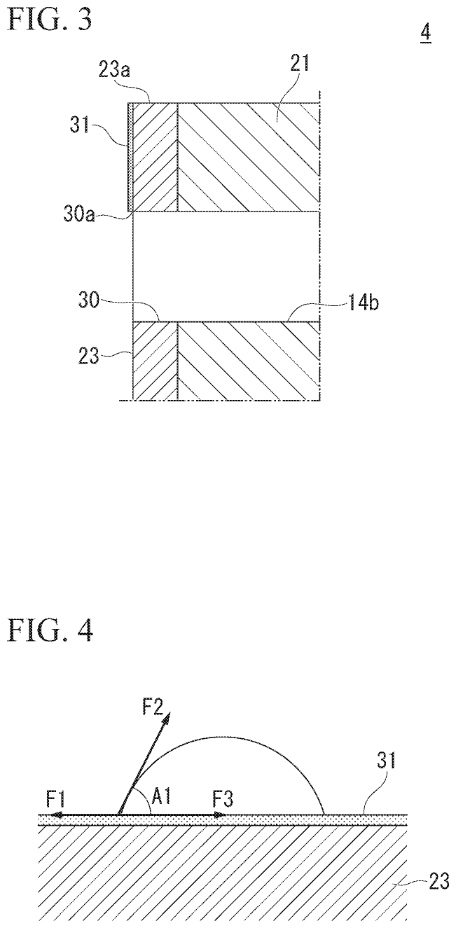

FIG. 3 is a cross-sectional view taken along line III-III of FIG. 2.

As shown in FIG. 3, the surface treatment portion 31 is a film which covers at least a space between the refrigerant flow hole 30 and the outer peripheral edge 23a of the end surface plate 23. A surface tension of the surface treatment portion 31 is smaller than that of the end surface plate 23. For example, the surface treatment portion 31 is formed by applying a material having a surface tension smaller than that of the end surface plate 23 along the outer periphery of the end surface plate 23. For example, the surface treatment portion 31 is a fluorine resin coating. For example, when the end surface plate 23 is formed of aluminum, the surface treatment portion 31 is a coating having a surface tension smaller than that of aluminum.

FIG. 4 is a diagram showing a contact angle in the surface treatment portion 31 of the first embodiment. In FIG. 4, a reference numeral F1 indicates a surface tension of the surface treatment portion 31, a reference numeral F2 indicates a surface tension of a liquid (refrigerant), a reference numeral F3 indicates a surface tension (an interface tension) between the surface treatment portion 31 and the refrigerant, and a reference numeral A1 indicates a contact angle. When a wet state is stable, a relationship between the contact angle A1 and the surface tensions F1 to F3 is expressed by the following equation (1) (Young's equation).

F1=F2×cos A1+F3 . . . (1)

When the above equation (1) is modified, the following equation (2) is obtained.

cos A1=(F1−F3)/F2

From the above equation (2), when the surface tension F1 of the surface treatment portion 31 is decreased, the contact angle A1 is increased, and thus it is easy to repel the refrigerant on the surface treatment portion 31. That is, the refrigerant flowing on the surface treatment portion 31 can be caused to easily slide by reducing the surface tension F1 of the surface treatment portion 31. For example, it is possible to make the refrigerant flowing on the surface treatment portion 31 easier to be repelled by making the contact angle A1 larger than 90° and making the surface treatment portion 31 water-repellent (oil repellent).

### <Flow of Refrigerant>

Hereinafter, a flow of the refrigerant in the first embodiment will be described with reference to FIG. 1 and the like.

In the embodiment, the axial center cooling is performed using the axial center refrigerant path 5a provided in the output shaft 5. The refrigerant is supplied to the axial center refrigerant path 5a by the refrigerant supply mechanism (not shown). Due to a centrifugal force accompanying rotation of the rotor 4, a force directed radially outward acts on the refrigerant. The refrigerant supplied to the axial center refrigerant path 5a is supplied to the rotor internal flow path 14 through the radial refrigerant path 5b by the centrifugal force. The refrigerant supplied to the rotor internal flow path 14 is discharged from the refrigerant flow hole 30 to the outside of the rotor 4 through the radial flow path 14a and the axial flow path 14b. In this way, the rotor core 21 is cooled by the refrigerant moving through the rotor internal flow path 14.

Some of the refrigerant discharged to the outside of the rotor 4 is distributed toward the coil end portion 12b.

Further, the remaining part of the refrigerant discharged to the outside of the rotor 4 moves radially outward along the surface treatment portion 31 and is distributed toward the coil end portion 12b. Accordingly, the coil 12 is cooled.

### <Operation>

Hereinafter, an operation of the rotary electric machine 1 of the first embodiment will be described.

First, a comparative example will be explained.

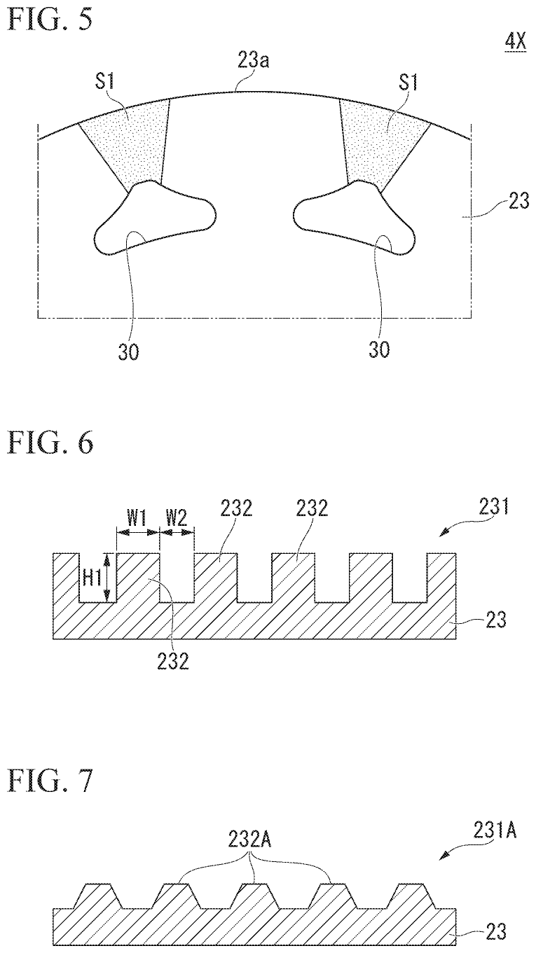

FIG. 5 is an enlarged view of a main part of a rotor 4X according to a comparative example when seen in the axial direction.

As shown in FIG. 5, the rotor 4X in the comparative example does not have the surface treatment portion 31 in the embodiment. In the comparative example, the refrigerant which has flowed out from the refrigerant flow hole 30 stays in place, and wetting spreads toward the outer peripheral edge 23a of the end surface plate 23. A reference numeral S1 in the drawing indicates a region in which the wetting due to the refrigerant spreads from the refrigerant flow hole 30 toward the outer peripheral edge 23a of the end surface plate 23.

In the comparative example, there is a high possibility that the refrigerant by which the wetting has spread toward the outer peripheral edge 23a of the end surface plate 23 may flow into a space (an air gap) between the inner peripheral surface of the stator and the outer peripheral surface of the rotor. Therefore, in the comparative example, the refrigerant which has flowed into the space between the inner peripheral surface of the stator and the outer peripheral surface of the rotor acts as a resistance against the rotation of the rotor, and rotational efficiency of the rotary electric machine may be lowered.

Next, the first embodiment will be described.

In the first embodiment, the surface treatment portion 31 is provided between the refrigerant flow hole 30 and the outer peripheral edge 23a of the end surface plate 23 on a surface (an outer surface in the axial direction) of the end surface plate 23 (refer to FIG. 3). Thus, the refrigerant which has flowed out from the refrigerant flow hole 30 can flow smoothly along the surface treatment portion 31 due to the centrifugal force accompanying the rotation of the rotor 4.

In addition, the surface tension of the surface treatment portion 31 is smaller than that of the end surface plate 23. Therefore, as compared with a case in which the surface tension of the surface treatment portion 31 is equal to or higher than that of the end surface plate 23, the refrigerant flowing on the surface treatment portion 31 can be caused to easily slide.

Thus, due to the centrifugal force accompanying the rotation of the rotor 4, it is possible to make it easier for the refrigerant flowing on the surface treatment portion 31 to be distributed radially outward. The refrigerant which has been distributed radially outward from the surface treatment portion 31 is less likely to flow into the space between the inner peripheral surface of the stator 3 and the outer peripheral surface of the rotor 4. Therefore, in the first embodiment, the possibility that the refrigerant acts as the resistance against the rotation of the rotor 4 is low, and the possibility that the rotation efficiency of the rotary electric machine 1 is lowered is low.

As described above, the rotary electric machine 1 of the embodiment includes the stator 3 having the cylindrical stator core 11 and the coil 12 mounted on the stator core 11, and the rotor 4 disposed on the radially inner side of the stator 3, the rotor 4 includes the rotor core 21 having the rotor internal flow path 14 through which the refrigerant can flow by the axial center cooling, and the end surface plate 23 disposed at the end of the rotor core 21 in the axial direction, the end surface plate 23 has the refrigerant flow hole 30 which communicates with the rotor internal flow path 14, and the surface treatment portion 31 disposed at least between the refrigerant flow hole 30 and the outer peripheral edge 23a of the end surface plate 23, and the surface tension of the surface treatment portion 31 is smaller than that of the end surface plate 23.

According to such a constitution, since the end surface plate 23 has the surface treatment portion 31 disposed at least between the refrigerant flow hole 30 and the outer peripheral edge 23a of the end surface plate 23, the refrigerant which has flowed out from the refrigerant flow hole 30 can flow smoothly along the surface treatment portion 31 due to the centrifugal force accompanying the rotation of the rotor 4. Therefore, as compared with a case in which the surface treatment portion 31 is not provided, the wetting and spreading toward the outer peripheral edge 23a of the end surface plate 23 due to causing the refrigerant which has flowed out from the refrigerant flow hole 30 to remain can be suppressed. In addition, since the surface tension of the surface treatment portion 31 is smaller than that of the end surface plate 23, as compared with a case in which the surface tension of the surface treatment portion 31 is equal to or higher than that of the end surface plate 23, the refrigerant flowing on the surface treatment portion 31 can be caused to easily slide. Therefore, due to the centrifugal force accompanying the rotation of the rotor 4, it is possible to make it easier for the refrigerant flowing on the surface treatment portion 31 to be distributed radially outward. Furthermore, as compared with a structure in which the wall body is provided on the inner peripheral surface side of the stator, the refrigerant which has flowed out from the refrigerant flow hole 30 is likely to be distributed to the coil 12 of the stator 3. Therefore, the rotational efficiency of the rotary electric machine 1 can be improved, and the coil 12 can be efficiently cooled. Also, since the surface treatment portion 31 is provided on each of the end surface plates 23 on both sides in the axial direction, each of the first coil end portion 12b1 and the second coil end portion 12b2 can be cooled. Accordingly, as compared with a case in which the surface treatment portion 31 is provided only on the one end surface plate 23, the coil 12 can be cooled more efficiently.

In the above-described embodiment, since the surface treatment portion 31 has the film which covers at least a space between the refrigerant flow hole 30 and the outer peripheral edge 23a of the end surface plate 23, the following effect is provided.

Due to the centrifugal force accompanying the rotation of the rotor 4, the refrigerant which has flowed out from the refrigerant flow hole 30 can slide on a surface of the film. For example, the film (the coating film) can be formed by applying a material having the surface tension smaller than that of the end surface plate 23 along the outer periphery of the end surface plate 23.

In the above-described embodiment, since the surface treatment portion 31 has the annular shape along the outer periphery of the end surface plate 23 when seen in the axial direction, the following effect is provided.

Due to the centrifugal force accompanying the rotation of the rotor 4, the refrigerant flowing on the surface treatment portion 31 can flow smoothly along the surface treatment portion 31 over the entire periphery of the end surface plate 23.

In the above-described embodiment, the example in which the surface tension of the surface treatment portion 31 is smaller than that of the end surface plate 23 has been described, but the present invention is not limited thereto. For example, the surface tension of the surface treatment portion 31 may be smaller than that of the refrigerant. That is, the surface tension of the surface treatment portion 31 may be smaller than that of at least one of the end surface plate 23 and the refrigerant.

In the above-described embodiment, the example in which the surface treatment portion 31 is a fluorine resin coating has been described, but the present invention is not limited thereto. For example, the surface treatment portion 31 may be n-hexane or n-pentane. Here, the surface tension of the ATF (oil) is about 20 mN/m. The surface tensions of various liquids at 20° C. are 18.40 mN/m for n-hexane and 16.00 mN/m for n-pentane. For example, when the ATF is used as the refrigerant, the surface treatment portion 31 is formed of an n-hexane or n-pentane film (for example, a coating film). Thus, the surface tension of the surface treatment portion 31 may be made smaller than that of the refrigerant.

### Second Embodiment

In the first embodiment, although the example in which the surface treatment portion 31 is a film which covers a space between the refrigerant flow hole 30 and the outer peripheral edge 23a of the end surface plate 23, the present invention is not limited thereto.

FIG. 6 is a cross-sectional view of a surface treatment portion 231 according to a second embodiment.

As shown in FIG. 6, the surface treatment portion 231 may have a fine concavo-convex structure. In a cross-sectional view, the surface treatment portion 231 has a rectangular concavo-convex shape. A reference numeral 232 in the drawing indicates a convex portion constituting the concavo-convex structure. A plurality of convex portions 232 are disposed on the surface of the end surface plate 23 with an interval therebetween. For example, the plurality of convex portions 232 are integrally formed of the same member as that of the end surface plate 23. For example, a width W1 of the convex portion 232, an arrangement interval W2 between the two adjacent convex portions 232 (hereinafter, also referred to as “pitch”), and a height H1 of the convex portion 232 have a length in the order of nanometers.

According to the second embodiment, since the surface treatment portion 231 has a fine concavo-convex structure, the contact area between the surface treatment portion 231 and the refrigerant is smaller than when the surface treatment portion is flat (it becomes a non-uniform wet state). Therefore, the refrigerant which has flowed out from the refrigerant flow hole can be repelled by the concavo-convex structure due to the centrifugal force accompanying the rotation of the rotor.

For example, it is preferable that the pitch W2 is smaller than the width W1 of the convex portion, and the height H1 of the convex portion is larger than the width W1 of the convex portion (W2<W1<H1). Thus, the refrigerant which has flowed out from the refrigerant flow hole can be more effectively repelled by the concavo-convex structure.

For example, it is preferable to form a film such as a fluorine resin coating on the surface of the concavo-convex structure. Thus, the refrigerant which has flowed out from the refrigerant flow hole can be more effectively repelled by the film.

In the above-described second embodiment, the example in which the plurality of convex portions 232 are integrally formed of the same member as that of the end surface plate 23 has been described, but the present invention is not limited thereto. For example, the plurality of convex portions 232 may be formed of a member different from that of the end surface plate 23 and may be integrally coupled to the end surface plate 23.

In the above-described second embodiment, the example in which the surface treatment portion 231 has the concavo-convex shape of a rectangular cross section has been described, but the present invention is not limited thereto.

For example, as shown in FIG. 7, a surface treatment portion 231A may have a plurality of convex portions 232A having a trapezoidal cross section.

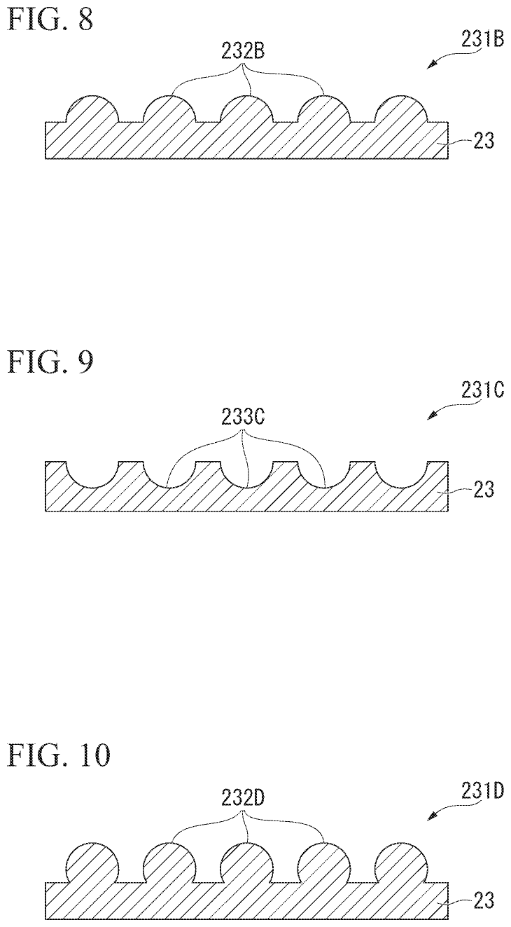

For example, as shown in FIG. 8, a surface treatment portion 231B may have a plurality of convex portions 232B having a semicircular cross section.

For example, as shown in FIG. 9, a surface treatment portion 231C may have a plurality of concave portion 233C having a semicircular cross section.

For example, as shown in FIG. 10, a surface treatment portion 231D may include a plurality of convex portions 232D having a circular cross section.

For example, the surface treatment portion may have a concavo-convex structure (knurls) formed by knurling. For example, for the knurls, types (flat pattern and diagonal pattern), shapes, and dimensions defined in the JIS standard (JIS B 0951-1962) may be applied.

In the above-described embodiment, the example in which the rotary electric machine 1 is a traveling motor mounted in a vehicle such as a hybrid vehicle or an electric vehicle has been described, but the present invention is not limited thereto. For example, the rotary electric machine 1 may be a motor for power generation, a motor for other uses, or a rotary electric machine (including a generator) other than for a vehicle.

In the above-described embodiment, the example in which the axial center cooling is performed using the axial center refrigerant path 5a provided in the output shaft 5 has been described, but the present invention is not limited thereto. For example, the refrigerant may be supplied to the magnet 22 along a guide wall (not shown) provided on the end surface plate 23 by the rotation of the rotor 4. For example, the refrigerant may be supplied to an opening portion of the end surface plate 23 through a supply port provided in the case 2 or the like.

In the above-described embodiment, the example in which the surface treatment portion is provided on each of the end surface plates 23 on both sides in the axial direction has been described, but the present invention is not limited thereto. For example, the surface treatment portion may be provided only on one end surface plate 23.

In the above-described embodiment, an example in which the radial refrigerant path 5b of the output shaft 5 extends outward radially from the axial center of the axial center refrigerant path 5a has been described, but the present invention is not limited thereto. For example, a plurality of the radial refrigerant paths 5b may be disposed at intervals in the axial direction. For example, the radial refrigerant path 5b may be disposed near the end of the rotor core 21 in the axial direction. In this case, the radial flow path 14a of the rotor internal flow path 14 may be disposed near the end of the rotor core 21 in the axial direction.

In the above-described embodiment, the example in which the surface treatment portion 31 has an annular shape along the outer periphery of the end surface plate 23 when seen in the axial direction has been described, but the present invention is not limited thereto. For example, the surface treatment portion may be provided only between the refrigerant flow hole 30 and the outer peripheral edge 23a of the end surface plate 23. For example, a plurality of surface treatment portions may be disposed at intervals along the outer periphery of the end surface plate 23. For example, the surface treatment portion may be provided on the entire surface of the end surface plate 23. In other words, the surface treatment portion may be disposed at least between the refrigerant flow hole 30 and the outer peripheral edge 23a of the end surface plate 23.

In the above-described embodiment, the example in which the refrigerant flow hole 30 has a triangular shape having the top portion 30a on the radially outer side when seen in the axial direction has been described, but the present invention is not limited thereto. For example, when seen in the axial direction, the refrigerant flow hole 30 may have a shape other than the triangular shape. For example, when seen in the axial direction, the refrigerant flow hole 30 may have a rectangular shape.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and is only limited by the scope of the appended claims.

What is claimed is:

1. A rotary electric machine comprising:
a stator including a cylindrical stator core, and a coil mounted on the stator core; and
a rotor disposed radially inward of the stator,
wherein the rotor includes a rotor core having a refrigerant flow path through which a refrigerant is able to flow due to axial center cooling, and an end surface plate disposed at an end of the rotor core in an axial direction,
the end surface plate includes a refrigerant flow hole configured to communicate with the refrigerant flow path, and a surface treatment portion disposed at least between the refrigerant flow hole and an outer peripheral edge of the end surface plate, and
a surface tension of the surface treatment portion is smaller than that of at least one of the end surface plate and the refrigerant.

2. The rotary electric machine according to claim 1, wherein the surface treatment portion has a film configured to cover at least a space between the refrigerant flow hole and the outer peripheral edge of the end surface plate.

3. The rotary electric machine according to claim 1, wherein the surface treatment portion has a fine concavo-convex structure.

4. The rotary electric machine according to claim 1, wherein the surface treatment portion has an annular shape along an outer periphery of the end surface plate when seen in the axial direction.
